(19) United States
(12) Patent Application Publication
(10) Pub. No.: US 2010/0180227 A1
(43) Pub. Date: Jul. 15, 2010

(54) METHOD, SYSTEM AND APPARATUS FOR A GRAPHICAL USER INTERFACE WITH HORIZONTAL WORKSPACE

(76) Inventor: Attaoulaye Diallo, Conakry (GN)

Correspondence Address: MAIER & MAIER, PLLC, 1000 DUKE STREET, ALEXANDRIA, VA, 22314, US

(21) Appl. No.: 12/550,491

(22) Filed: Aug. 31, 2009

Related U.S. Application Data
(60) Provisional application No. 61/144,218, filed on Jan. 13, 2009.

(51) Int. Cl. G06F 3/048; G06T 15/00

(52) U.S. Cl. 715/782; 345/419

(57) ABSTRACT

A method, system and apparatus for a graphical user interface with horizontal workspace. The graphical user interface may display a plurality of quadrilateral screen subsystems. Each screen subsystem may operate at least one application, contain at least one sub-explorer of files and folders, communicate with a main system explorer through a unique port, and communicate with each of the other plurality of screen subsystems.

### PRIORITY

This application claims priority to provisional patent application No. 61/144,218 filed on Jan. 13, 2009.

### BACKGROUND

In computer applications which utilize graphical interfaces, the graphical presentation may be the first aspect persons consider before purchasing the product. The graphical user interface displayed on a computer screen allows people to interact with electronic devices such as computers, MP3 Players, Portable Media Players, gaming devices; household appliances and office equipment with images rather than text commands. Therefore, the format and layout of a graphical user interface is important for effective and efficient use of any computer application.

Graphical user interfaces are known in the art. However traditional graphical user interfaces on a computer screen are rendered vertically as flat, two-dimensional displays. Additionally, while some computer applications allow a person to have multiple graphical user interfaces open simultaneously, it is only possible to view and use one graphical user interface at a time either by switching between tabs or minimizing one application.

### SUMMARY

One embodiment of the present invention may show a method, system and apparatus for displaying a graphical user interface. The graphical user interface may display a plurality of quadrilateral screen subsystems. Each screen subsystem may be operating at least one application, contain at least one sub-explorer of files and folders, communicate with a main system explorer through a unique port, and communicate with each of the other plurality of quadrilateral screen subsystems.

Another embodiment of the present invention may show a method, system and apparatus for displaying a graphical user interface. The graphical user interface may display a plurality of quadrilateral screen subsystems. The plurality of quadrilateral screen subsystems may include a horizontal screen subsystem, right lateral screen subsystem, left lateral screen subsystem, vertical front screen subsystem and top screen subsystem in a manner that presents a three dimensional working environment.

### BRIEF DESCRIPTION OF THE FIGURES

FIG. 1 is an exemplary graphical user interface with a horizontal workspace.

FIG. 2. is another exemplary graphical user interface with a horizontal workspace.

FIG. 3 is another exemplary graphical user interface with left and right lateral screen subsystems.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiments” or “invention” do not require that all embodiments of the method, system or apparatus include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

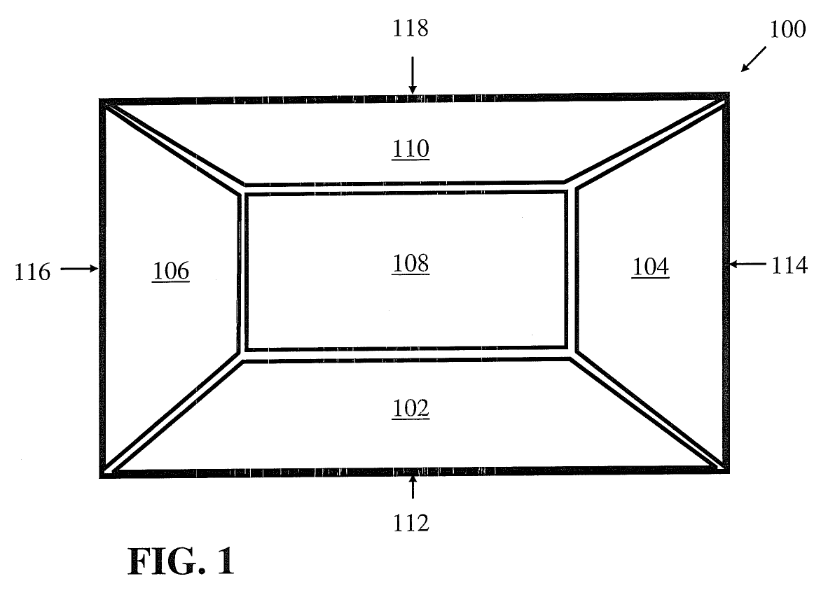

Generally referring to FIGS. 1-3, a method, system and apparatus for a graphical user interface with horizontal workspace may be disclosed. The graphical user interface may display a plurality of quadrilateral figures which may be trapezoidal, square, rectangular, or the like. Each of the plurality of quadrilateral figures may represent a screen subsystem. Each screen sub-system may be a polygon of 4 summits and may be presented as is in a real view of a physical object. Any screen sub-systems may communicate with each other. If an application is frozen in one screen sub-system the other screen sub-systems may not be affected. Each screen sub-system may have a sub-explorer of files and folder. Any of the sub-explorers may communicate to a main system explorer through a unique port.

In one exemplary embodiment, as shown in FIG. 1, graphical user interface 100 may have horizontal screen subsystem 102. Horizontal screen subsystem 102 may be presented as laid down and flat horizontally. Horizontal screen subsystem 102 may also be a quadrilateral. Horizontal screen subsystem 107 may be presented, for example, as a screen in the classical vertical position that has been rotated about bottom axis 112. Horizontal screen subsystem 102 may be used for any of a plurality of applications, for example, office applications including word processing, spreadsheet, email applications, other programs or any computing element. Horizontal screen subsystem 102 may be rotated about bottom axis 112 to increase or decrease the angle of presentation to a user.

Still with respect to FIG. 1, graphical user interface 100 may have a right lateral screen subsystem 104. Right lateral screen subsystem 104 may be a quadrilateral. Right lateral screen subsystem 104 may be presented, for example, as a screen in the classic vertical position that has been rotated about right side axis 114. Right lateral screen subsystem 104 may be used for any of a plurality of applications, for example, displaying a picture, painting, photograph, characters, symbol fonts, graphical components, other programs or any computing element. Right lateral screen subsystem 104 may be rotated about right axis 114 to increase or decrease the angle of presentation to a user.

Still with respect to FIG. 1, graphical user interface 100 may have a left lateral screen subsystem 106. Left lateral screen subsystem 106 may be a quadrilateral. Left lateral screen subsystem 106 may be presented, for example, as a screen in the classic vertical position that has been rotated about left side axis 116. Left lateral screen subsystem 106 may be used for any of a plurality of applications, for example, displaying a picture, painting, photograph, characters, symbol fonts, graphical components or any other application. Left lateral screen subsystem 106 may be rotated about left axis 116 to increase or decrease the angle of presentation to a user.

Still with respect to FIG. 1, graphical user interface 100 may have a vertical front screen subsystem 108. Vertical front screen subsystem 108 may be a quadrilateral. Vertical front screen subsystem 108 may be presented, for example, as a screen in the classic vertical position that has been moved back a distance from the full screen. Vertical front screen subsystem 108 may be used for any of a plurality of applications, for example, displaying videos, pictures, photographs, paintings, characters, symbol fonts, graphical components, other programs or any other computing element. Vertical front screen subsystem 108 may be moved forward or back on a plane to increase or decrease the size of presentation to a user.

Still with respect to FIG. 1, graphical user interface 100 may have a top screen sub system 110. Top screen subsystem 110 may be a quadrilateral. Top screen subsystem 110 may be presented, for example as a screen in the classic vertical position that has been rotated about top axis 118. Top screen subsystem may be rotated about top axis 118 to increase or decrease the angle of presentation to a user. Top screen subsystem 110 may be used for any of a plurality of applications, for example, internet browsing, office applications, other programs or any other computing element. Top screen subsystem 110 may be used to reinitialize frozen applications from other screen subsystems or transfer work from one screen subsystem to another.

In an exemplary embodiment as depicted in FIG. 1, the user may see a computer screen as a three dimensional working area. Graphical user interface 100 may allow a user to work with multiple applications simultaneously without switching between application windows. Data entered onto any screen subsystem may be saved by another screen subsystem concurrently to prevent loss of information should the first screen subsystem fail. Data may be saved by another screen subsystem automatically. For example, data entered into horizontal subsystem screen 102, may by default be saved by right lateral screen subsystem 104. Any of the screen subsystems may be designated to display a menu that may contain all historical data files across all screen subsystems. For example top screen subsystem 110 may be designated to display a menu containing historical data for files saved on all the other screen subsystems. Graphical user interface 100 may optimize a user's experience when working with multiple input documents.

Each screen subsystem may have a unique sub-explorer for searching data local to the screen subsystem. For example, if a user seeks to open data in the horizontal screen subsystem, the user may first solicit the horizontal subsystem sub-explorer. The sub-explorer may localize a program or file to launch or open in that subsystem screen. The sub-explorer may be viewed or accessed by clicking on an icon or by any equivalent act. The graphical user interface may display at least one or more virtual operating systems in one or more screen subsystem.

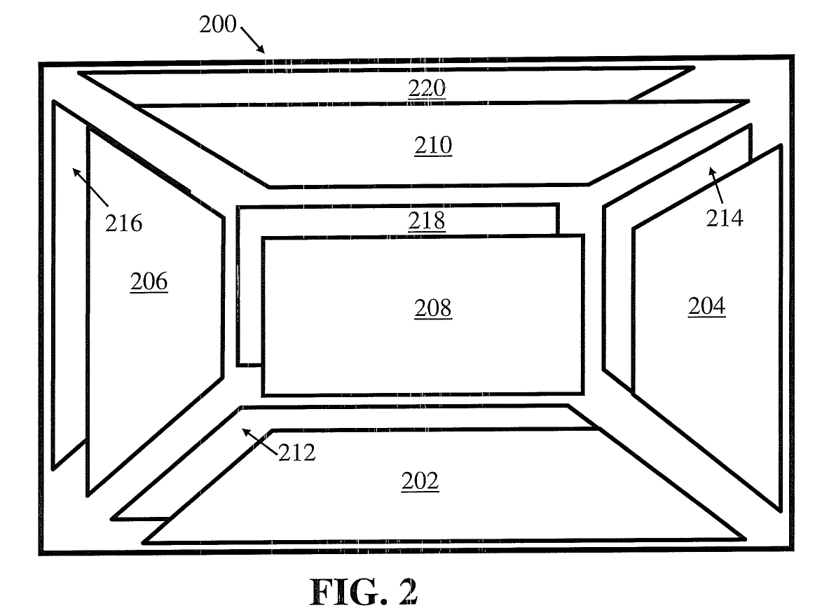

In another exemplary embodiment, as shown in FIG. 2, graphical user interface 200 may have horizontal screen subsystem 202, right lateral screen subsystem 204, left lateral screen subsystem 206, vertical front screen subsystem 208 and top screen subsystem 210. Each screen subsystem may also have another overlapping application form. For instance, horizontal screen subsystem 202 may have additional overlapping application form 212. Right lateral screen subsystem 204 may have overlapping application form 214. Left lateral screen subsystem 206 may have overlapping application form 216. Vertical front screen subsystem 208 may have overlapping application form 218. Top screen subsystem 201 may have overlapping screen subsystem 220.

Still in reference to FIG. 2, a user may select one of the overlapping forms to bring this application to the front. A user may then interact directly with an application form. The embodiment shown in FIG. 2 may allow a user to interact with even more application forms. Each screen subsystem may have a plurality of overlapping forms. Alternatively, two or more screens may be visible in a subsystem at the same time. For example, instead of one vertical front screen subsystem 208, graphical user interface 200 may show two vertical front screen subsystems simultaneously.

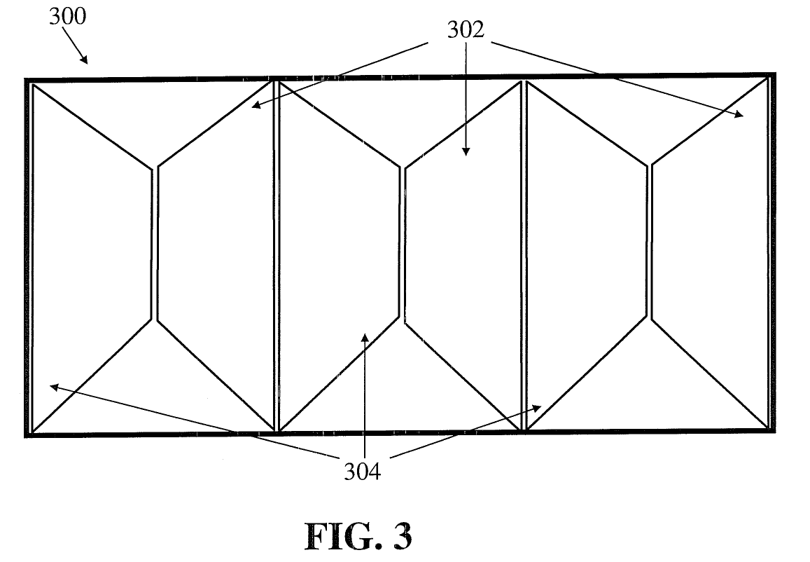

In another exemplary embodiment, as shown in FIG. 3, graphical user interface 300 may be displayed. Graphical user interface 300 may show an example of a customized workspace using a variety of quadrilateral screen subsystems. For example, graphical user interface may have a plurality of left lateral screen subsystems 302 and a number of right lateral screen subsystems 304. The screen subsystems may be arranged in any number of ways to present a unique graphical user interface, including that shown by graphical user interface 300. A customized graphical user interface may allow a user to design a system to fit their desired needs. For example, graphical user interface may be useful for any number of applications including data processing where multiple pages or sheets may be displayed.

For all exemplary embodiments, each screen subsystem may have command buttons, files and folders that may be displayed in any known or desired manner. The files/folders may be dragged and dropped between screen sub-systems. All application forms belonging to a screen sub-system may have a unique handle. Each screen sub-system may have a space in memory which is dedicated with a minimum of memory available for launching applications. Each screen sub-system may further display at least one of any other type of screen subsystem.

A core system may monitor each screen sub-system's functionality and adjust as necessary the memory. By default, all copied data may be held into a file which can be handled by a designated screen sub-system. Thus, a problem with a particular screen sub-system will not effect the retrieval of data at another screen sub-system. The designated screen sub-system may get a copy of any data file as backup that the user worked on for a given period. Alternatively, any screen sub-system may have a virtual disk drive with a capacity and all peripheral devices such as CD/DVD/USB drives mapped.

The foregoing description and accompanying drawings illustrate the principles, preferred embodiments and modes of operation of the invention. However, the invention should not be construed as limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of displaying a graphical user interface said method implemented using a computer system having a processor configured to:
display a plurality of quadrilateral screen subsystems, each screen subsystem operating at least one application, containing at least one sub-explorer of files and folders, communicating with a main system explorer through a unique port, and communicating with each of the other plurality of quadrilateral screen subsystems.

2. The method of claim 1 wherein the processor is further configured to:
display the plurality of quadrilateral screen subsystems as any of a horizontal screen subsystem, a right lateral screen subsystem, a left lateral screen subsystem, a vertical front screen subsystem, a top screen subsystem.

3. The method of claim 2 wherein the processor is further configured to:
display the horizontal screen subsystem as a screen in the classic vertical position that has been rotated about the bottom axis.

4. The method of claim 2 wherein the processor is further configured to:
display the right lateral screen subsystem as a screen in the classic vertical position that has been rotated about the right axis.

5. The method of claim 2 wherein the processor is further configured to:
display the left lateral screen subsystem as a screen in the classic vertical position that has been rotated about the left axis.

6. The method of claim 2 wherein the processor is further configured to:
display the front vertical screen subsystem as a screen in the classic vertical position that has been moved back a distance.

7. The method of claim 2 wherein the processor is further configured to:
display the top screen subsystem as a screen in the classic vertical position that has been rotated about the top axis.

8. The method of claim 1 wherein the processor is further configured to:
substantially simultaneously save application data in both the local screen subsystem and at least one other screen subsystem.

9. The method of claim 1 wherein the applications further comprise:
office applications including word processing, spreadsheet, email, and displaying a picture, painting, photograph, video, characters, symbol fonts, or other graphical components.

10. The method of claim 1 wherein the processor is further configured to:
transfer application data from one screen subsystem to another screen subsystem.

11. The method of claim 1 wherein the processor is further configured to:
designate one screen subsystem to display a menu containing historical data for files saved on all the other screen subsystems.

12. The method of claim 1 wherein the processor is further configured to:
allow a user to view multiple applications across the plurality of screen subsystems simultaneously without switching between application windows.

13. The method of claim 2 wherein the processor is further configured to:
permit a user to customize a graphical user interface using any combination of the plurality of quadrilateral screen subsystems.

14. The method of claim 2 wherein the processor is further configured to:
display at least one of type of screen subsystem within another screen subsystem.

15. A method of displaying a graphical user interface said method implemented using a computer system having a processor configured to:
display a plurality of quadrilateral screen subsystems including a horizontal screen subsystem, right lateral screen subsystem, left lateral screen subsystem, vertical front screen subsystem and top screen subsystem in a manner that presents a three dimensional working environment.

16. The method of claim 14 wherein the processor is further configured to:
display at least one overlapping quadrilateral screen subsystem for each of the plurality of quadrilateral screen subsystems.
